(19) United States
(12) Patent Application Publication
(10) Pub. No.: US 2009/0233245 A1
(43) Pub. Date: Sep. 17, 2009

(54) Color Film Developer Composition and Process Therefor

(76) Inventors: Robert Arthur Olson, Moorpark, CA (US); Michael Anthony Zacharia, Canyon Country, CA (US); Warren Proulx, Burbank, CA (US)

Correspondence Address: Thomson Licensing LLC, P.O. Box 5312, Two Independence Way, PRINCETON, NJ, 08543-5312, US

(21) Appl. No.: 11/922,827

(22) PCT Filed: Jun. 5, 2006
(86) PCT No.: PCT/US2006/021623

§ 371 Date: Dec. 20, 2007

Related U.S. Application Data
(60) Provisional application No. 60/696,558, filed on Jul. 5, 2005.

(51) Int. Cl. G03C 5/00

(52) U.S. Cl. 430/433; 430/467

(57) ABSTRACT

A method and composition for processing color film is described. The color film is processed by developing it using first and second compositions. The second composition is an aqueous composition including a buffer, an antioxidant, a preservative, a hydroxide and a developer selected from the group consisting of a hydroquinone and an ascorbic acid.

### BACKGROUND OF THE INVENTION

1. Field of the Invention

The present invention relates to film development processes and, more particularly to color film development processes and developers therefor.

2. Description of the Background Art

Images captured in printed pictures or on film are used to communicate information and ideas. Color film based images are typically produced by irradiating a silver halide-based emulsion thereon to produce a latent image in the silver halide grains of the emulsion. The exposed color film may then be conventionally developed using a wet chemical developing process.

Conventional wet chemical developing processes generally utilize a series of tanks containing various processing solutions. The undeveloped exposed color film is fully immersed into each of the tanks containing the various processing solutions. A typical wet chemical developing process includes a single development step in which the exposed film is immersed in individual tanks for developing, fixing, bleaching and drying, as well as various rinsing operations. Such conventional wet chemical developing processes remove a portion of the silver and silver halide from the emulsion to produce a color dye image on the film.

For some wet chemical developing processes, it is important to increase the silver retention of the processed color film in order to achieve a unique look, such as, for example, cleaner highlights, blacker blacks and desaturated color. Challenges to wet chemical development processes when increasing the silver retention of the color film are that the highlights can be muddy and color timing may be difficult to achieve.

Thus, it would be desirable to increase silver retention on processed color film.

### SUMMARY OF THE INVENTION

The present invention relates to a method and composition for processing color film. The color film is processed by developing it using first and second compositions. The second composition is an aqueous composition including a buffer, an antioxidant, a preservative, a hydroxide and a developer selected from the group consisting of a hydroquinone and an ascorbic acid.

### BRIEF DESCRIPTION OF THE DRAWINGS

The invention will now be described in greater detail, with relation to the accompanying drawings, in which

FIG. 1 is a schematic diagram illustrating a wet chemical development process of the present invention; and

FIG. 2 is a flow diagram illustrating the process steps used for the wet chemical development process detailed in FIG. 1.

### DETAILED DESCRIPTION

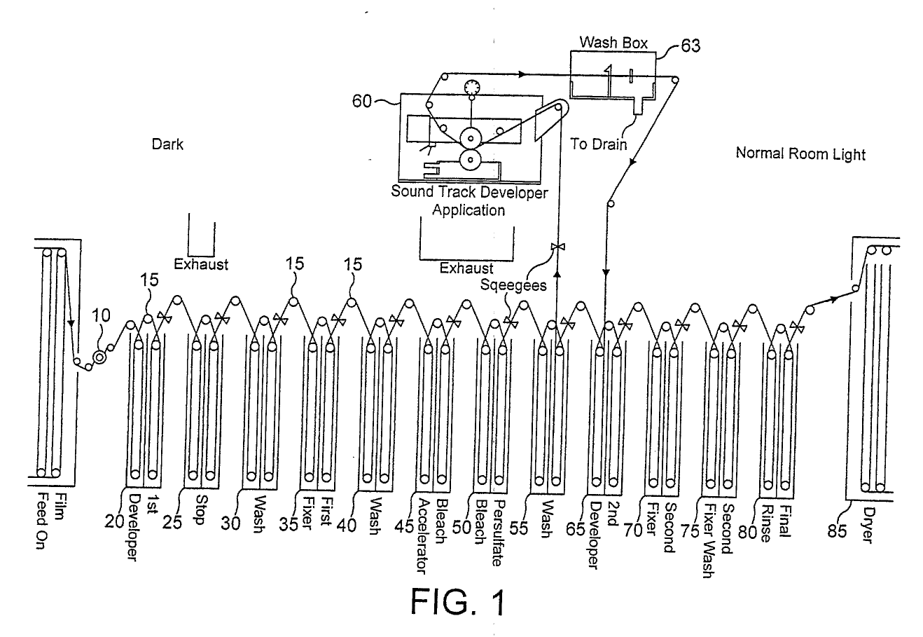

FIG. 1 is a schematic illustration for a conventional wet chemical development process for color film. As shown in FIG. 1, color film 10 is fed via rollers 15 into various tanks during the development process including a first development tank 20, a stop tank 25, a first wash tank 30, a first fixer tank 35, a second wash tank 40, a bleach accelerator tank 45, a persulfate bleach tank 50, a third wash tank 55, a sound track applicator tank 60, a fourth wash tank 63, a second developer tank 65, a second fixer tank 70, a second fixer wash tank 75 and a final rinse tank 80. The color film 10 travels through the various tanks during the development process at a speed between about 400 fpm (feet per minute to about 1000 fpm.

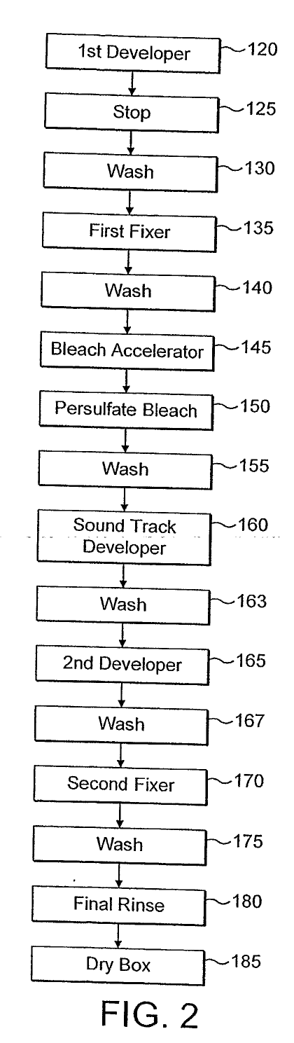

The color film 10 is developed according to the process steps shown in the flow chart of FIG. 2. Initially, the color film 10 is immersed in a first developer tank 20, as indicated by reference numeral 120. The first developer tank 20 includes an industry standard color film developing solution which transforms the latent image exposed on the film into a visible image when the color film is immersed therein. The first developing solution develops the exposed silver halide in the color film and reacts with color coupling agents in the film to create dye layers along with a silver image.

Time and temperature control are especially important for optimum image quality. The conditions (e.g., time of development, temperature of the developer solution, etc.) may vary according to industry standards. For example, the developer solution is typically held at a temperature of about 90° C. The color film 10 may travel through the first developer tank 20 during the development process at a speed between about 400 fpm (feet per minute to about 1000 fpm.

As indicated by reference numeral 125 in FIG. 2, after the film is developed in the first developer tank 20, it is immersed in a stop tank 25. The stop tank 25 includes a stop bath typically comprising a dilute acid solution which stops the development in the color film and removes the developer solution from the film surface. For example, the stop bath may be a dilute solution of acetic acid.

After the color film 10 is immersed in the stop tank 25 it is washed in the first wash tank 30, indicated by reference numeral 130. The first wash tank 30 uses water to remove the dilute acid stop bath from the color film surface.

The color film 10 is next immersed in a first fixer tank 35, as indicated by reference numeral 135. The first fixer comprises an industry standard fixer solution which makes the visible image in the developed film permanent and light insensitive.

As indicated by reference numeral 140 in FIG. 2, after the film is fixed in the first fixer tank 35, it is immersed in a second wash tank 40. The second wash tank 40 uses water to remove the fixer solution from the color film surface.

After the color film 10 is immersed in the second wash tank 40 it is provided to a bleach accelerator tank 45, indicated by reference numeral 145. The bleach accelerator tank 45 includes an industry standard bleach accelerator solution.

The color film 10 is next immersed in a persulfate bleach tank 50, as indicated by reference numeral 150. The persulfate bleach tank 50 includes an industry standard persulfate bleach solution which converts the visible image formed by the developer solution into silver halide.

As indicated by reference numeral 155 in FIG. 2, after the film is bleached in the persulfate bleach tank 50 it is immersed in a third wash tank 55. The third wash tank 55 uses water to remove the persulfate bleach solution from the color film surface.

After the color film 10 is immersed in the third wash tank 55, it is provided to a sound track applicator tank 60, indicated by reference numeral 160. The sound track applicator tank 60 includes an industry standard sound track developer solution to develop the sound track in the color film.

As indicated by reference numeral 163 in FIG. 2, after the film is developed in the sound track applicator tank 60, it is immersed in a fourth wash tank 63. The fourth wash tank 63 uses water to remove the sound track developer solution from the color film surface.

After the color film 10 is immersed in the fourth wash tank 63 it is provided to a second developer tank 65, indicated by reference numeral 165. The second developer tank 65 includes second developer solution of an aqueous composition including a buffer, an antioxidant, a preservative, a hydroxide and a developer selected from the group consisting of a hydroquinone and an ascorbic acid.

The second developer solution increases silver retention on the processed color film to achieve cleaner highlights, blacker blacks and desaturated color. In order to achieve the cleaner highlights, blacker blacks and desaturated color this second development of the color film is performed after the sound track development step and before a subsequent second fixing step (discussed below).

The second developer solution should include hydroquinone within a range of about 3.5% weight/volume to about 5.5% weight/volume. Alternatively, the second developer solution should include the ascorbic acid within a range of about 3.5% weight/volume to about 5.5% weight/volume.

The buffer may be a carbonate, such as sodium carbonate. Other suitable carbonates may include, for example potassium carbonate and ammonium carbonate. The second developer solution should include carbonate within a range of about 1.5% weight/volume to about 2.5% weight/volume.

The antioxidant and preservative may comprise the same material, such as, for example sodium sulfite. Other suitable examples may include potassium sulfite and ammonium sulfite. The second developer solution should include the antioxidant and preservative within a range of about 2% weight/volume to about 4% weight/volume.

The hydroxide is used to adjust the pH of the aqueous composition and may be sodium hydroxide. Other suitable examples may include potassium hydroxide and ammonium hydroxide. The second developer solution should include the hydroxide within a range of about 1.5% weight/volume to about 2% weight/volume.

In one exemplary wet chemical color film development process, a 1 liter second developer solution is made by adding to 800 ml of water at about 90° C., 20-40 grams of sodium sulfite, 35-55 grams of hydroquinone, 15-25 grams of sodium carbonate and 18 grams of sodium hydroxide (for pH adjustment). Water is then added to bring the composition to 1 liter and additional sodium hydroxide added to correct the pH to 10.90±0.10. Deionized water may be used to make the second developer solution, although deionized water is not required.

In another exemplary wet chemical color film development process, a 1 liter second developer solution is made by adding to 800 ml of water at about 90° C., 20-40 grams of sodium sulfite, 40-65 grams of ascorbic acid, 15-25 grams of sodium carbonate and 18 grams of sodium hydroxide (for pH adjustment). Water is then added to bring the composition to 1 liter and additional sodium hydroxide added to correct the pH to 10.90±0.10. Deionized water may again be used to make the second developer solution, although deionized water is not required.

As indicated by reference numeral 167 in FIG. 2, after the film is developed in the second developer tank 65, it is immersed in a fifth wash tank (not shown in FIG. 1). The fifth wash tank uses water to remove the second developer solution from the color film surface.

After the color film 10 is immersed in the fifth developer tank, it then provided to a second fixer tank 70, as indicated by reference numeral 170. The second fixer tank 70 comprises an industry standard fixer solution which removes the silver halide formed during bleaching from the color film.

As indicated by reference numeral 175 in FIG. 2, after the film is fixed in the second fixer tank 70 it is immersed in a second fixer wash tank 75. The second fixer wash tank 75 uses water to remove the second fixer solution from the color film surface.

After the color film 10 is immersed in the second fixer wash tank 75, it then immersed in a final rinse tank 80, as indicated by reference numeral 180. The final rinse tank 80 includes an industry standard final rinse solution to aid in the subsequent drying of the color film.

As indicated by reference numeral 185 in FIG. 2, after the film is finally rinsed in the final rinse tank 80, it is dried in a drybox 85. In the drybox 85, the film is dried using standard drying temperatures. Thereafter the dried film is wound on spools for subsequent projection or printing.

During the exemplary wet chemical development process described above, the second developer solution may become depleted. When the second developer composition becomes depleted, a replenisher solution may be added thereto.

In one exemplary wet chemical color film development process, a 1 liter second developer replenisher solution is made by adding to 800 ml of water at about 90° C., 30 grams of sodium sulfite, 55 grams of hydroquinone, 20 grams of sodium carbonate and 18 grams of sodium hydroxide (for pH adjustment). Water is then added to bring the composition to 1 liter and additional sodium hydroxide added to correct the pH to 10.90±0.10. Deionized water may be used to make the second developer replenisher solution, although deionized water is not required.

Although an exemplary method and composition for processing color film using a second developer which incorporates the teachings of the present invention has been shown and described in detail herein, those skilled in the art can readily devise many other varied embodiments that still incorporate these teachings.

1. A method for processing color film, comprising:
developing color film in first and second compositions, wherein the second composition is an aqueous composition including a buffer, an antioxidant, a preservative, a hydroxide and a developer selected from the group consisting of a hydroquinone and an ascorbic acid.

2. The method of claim 1 wherein the buffer is selected from the group consisting of sodium carbonate, potassium carbonate and ammonium carbonate.

3. The method of claim 1 wherein the antioxidant and the preservative comprise the same material.

4. The method of claim 1 wherein the antioxidant is selected from the group consisting of sodium sulfite, potassium sulfite and ammonium sulfite.

5. The method of claim 1 wherein the preservative is selected from the group consisting of sodium sulfite, potassium sulfite and ammonium sulfite.

6. The method of claim 1 wherein the hydroxide is selected from the group consisting of sodium hydroxide, potassium hydroxide and ammonium hydroxide.

7. The method of claim 1 wherein the developer is present in an amount of about 3.5% weight/volume to about 5.5% weight/volume.

8. An aqueous composition for processing color film after sound track development, comprising:
a buffer, an antioxidant, a preservative, a hydroxide and a developer selected from the group consisting of a hydroquinone and an ascorbic acid.

9. The aqueous composition of claim 8 wherein the buffer is selected from the group consisting of sodium carbonate, potassium carbonate and ammonium carbonate.

10. The aqueous composition of claim 8 wherein the antioxidant and the preservative comprise the same material.

11. The aqueous composition of claim 8 wherein the antioxidant is selected from the group consisting of sodium sulfite, potassium sulfite and ammonium sulfite.

12. The aqueous composition of claim 8 wherein the preservative is selected from the group consisting of sodium sulfite, potassium sulfite and ammonium sulfite.

13. The aqueous composition of claim 8 wherein the hydroxide is selected from the group consisting of sodium hydroxide, potassium hydroxide and ammonium hydroxide.

14. The aqueous composition of claim 8 wherein the developer is present in an amount of about 3.5% weight/volume to about 5.5% weight/volume.
